(19) United States
(12) Patent Application Publication
(10) Pub. No.: US 2026/0352431 A1
(43) Pub. Date: Nov. 5, 2026

(54) RADIO FREQUENCY MODULE AND COMMUNICATION APPARATUS

(71) Applicant: Murata Manufacturing Co., Ltd., Nagaokakyo-shi (JP)

(72) Inventor: Keisuke ARIMA, Nagaokakyo-shi (JP)

(73) Assignee: Murata Manufacturing Co., Ltd., Nagaokakyo-shi (JP)

(21) Appl. No.: 19/735,576

(22) Filed: Jul. 9, 2026

Related U.S. Application Data
(63) Continuation of application No. PCT/JP2024/042797, filed on Dec. 4, 2024.

(30) Foreign Application Priority Data
Jan. 24, 2024 (JP) 2024-008756

(51) Int. Cl. H04L 5/00; H04B 1/50

(52) U.S. Cl. CPC H04L 5/0098; H04B 1/50

(57) ABSTRACT

A radio frequency module includes a module substrate, a first filter disposed on the module substrate and having a passband including a sending band of a band (A) corresponding to a first power class, a second filter disposed on the module substrate and having a passband including a receiving band of the band (A), and a third filter disposed on the module substrate and having a passband including at least part of a band (C) corresponding to a second power class that is specified according to a maximum output power lower than a maximum output power of the first power class. The third filter is interposed between two elements selected from the group consisting of the power amplifier, the first filter, and the second filter in a plan view of the module substrate.

### CROSS-REFERENCE TO RELATED APPLICATIONS

The present application is a continuation application of International Application No. PCT/JP2024/042797, filed on Dec. 4, 2024, which claims priority to Japanese Patent Application No. 2024-008756, filed on Jan. 24, 2024. The entire contents of each of these applications are incorporated herein by reference.

### TECHNICAL FIELD

The present disclosure relates to a radio frequency module and a communication apparatus.

### BACKGROUND ART

The use of a frequency division duplex (FDD) band in a power class (such as Power Class 2, 1.5, or 1) specified as having a maximum output power higher than that of power classes used in the related art has been discussed in the 3rd Generation Partnership Project (3GPP) (registered trademark) or the like.

### CITATION LIST

### Patent Document

Patent Document 1: Japanese Unexamined Patent Application Publication No. 2017-063315

### SUMMARY

A radio frequency module according to an aspect of the present disclosure includes: a module substrate, a first filter disposed on the module substrate and having a passband including a sending band of a first FDD band corresponding to a first power class, a second filter disposed on the module substrate and having a passband including a receiving band of the first FDD band, and a third filter disposed on the module substrate and having a passband including at least part of a second band corresponding to a second power class that is specified according to a maximum output power lower than a maximum output power of the first power class. The third filter is disposed between the first filter and the second filter in plan view of the module substrate.

A communication apparatus according to an aspect of the present disclosure includes a signal processing circuit configured to process a radio frequency signal; and the above-described radio frequency module configured to transmit the radio frequency signal between the signal processing circuit and an antenna.

According to the present disclosure, the deterioration in the receiving characteristics of a FDD band may be reduced.

### BRIEF DESCRIPTION OF DRAWINGS

FIG. 1 is a circuit configuration diagram of a communication apparatus according to Embodiment 1.

FIG. 2 is a plan view of a radio frequency module according to Embodiment 1.

FIG. 3 is a plan view of the radio frequency module according to Embodiment 1.

FIG. 4 is a cross-sectional view of the radio frequency module according to Embodiment 1.

FIG. 5 is a plan view of a radio frequency module according to Modification 1 of Embodiment 1.

FIG. 6 is a plan view of a radio frequency module according to Modification 2 of Embodiment 1.

FIG. 7 is a circuit configuration diagram of a communication apparatus according to Embodiment 2.

FIG. 8 is a plan view of the radio frequency module according to Embodiment 2.

FIG. 9 is a plan view of the radio frequency module according to Embodiment 2.

FIG. 10 is a cross-sectional view of the radio frequency module according to Embodiment 2.

### DESCRIPTION OF EMBODIMENTS

However, the inventor has recognized that if the maximum output power higher than that used in the related art is allowed for the FDD band in a radio frequency circuit described in Patent Document 1, the receiving characteristics of the FDD band are deteriorated in some cases.

The present disclosure is directed to providing a radio frequency module and a communication apparatus that are enabled to reduce the deterioration in the receiving characteristics of the FDD band.

Hereinafter, embodiments of the present disclosure will be described in detail by using the drawings. The embodiments described below each illustrate a general or specific example. The numerical values, shapes, materials, components, the disposition and connection form of the components, and the like described in the following embodiments are examples and are not intended to limit the present disclosure. Unless expressly stated otherwise, each component, circuit, and structural arrangement described herein is optional and may be omitted, substituted, or combined with other components in alternative embodiments. The described embodiments are illustrative and not limiting.

The drawings are schematic diagrams having undergone emphasis, omission, or ratio adjustment performed as appropriate to illustrate the present disclosure. The illustration therein is not necessarily strict and is different from actual shapes, positional relationships, and ratios on occasions. In the drawings, components that are substantially the same are denoted by the same reference numerals, and a repeated description thereof is omitted or simplified in some cases.

In the drawings below, an x axis and a y axis are axes orthogonal to each other on a plane parallel to a main surface of a module substrate. Specifically, when the module substrate is rectangular in plan view, the x axis is parallel to first sides of the module substrate, and the y axis is parallel to second sides orthogonal to the first sides of the module substrate. The z axis is perpendicular to the main surface of the module substrate, and the positive direction thereof represents an upward direction, and the negative direction represents a downward direction.

In the description of the following circuit configurations, the term “connected” includes not only a direct connection using a connection terminal and/or a wiring conductor but also an electrical connection via another circuit element. The phrase “A is connected to B in a switchable manner” means that connection and non-connection between A and B are switchable and that A is connected to B with a switch interposed therebetween. The phrase “A is connected to B” includes the phrase “A is connected to B in a switchable manner”. The phrase “C is connected between A and B” means that one end of C is connected to A, that the other end of C is connected to B, and that C is disposed in series on a path connecting A and B. The phrase “a path connecting A and B” means a path formed from a conductor that electrically connects A to B.

The term “terminal” means a point at which a conductor in an element terminates. In a case where the impedance of a conductor between elements is sufficiently low, a terminal is interpreted as not only a single point but also any point on the conductor between the elements or the entire conductor.

The term “a passband of a filter” is part of a frequency spectrum transmitted through a filter and a frequency range in which output power is not attenuated from the maximum output power by 3 dB or greater. A higher end of the passband of a band pass filter is decided as a higher frequency point of two points between which the output power is attenuated from the maximum output power by 3 dB, and a lower end thereof is decided as a lower frequency point.

The term “sending band” means a frequency band used for sending by a communication apparatus, and the term “receiving band” means a frequency band used for receiving by the communication apparatus. For example, in a FDD band, mutually different frequency bands (an uplink band and a downlink band) are used as the sending band and the receiving band. In addition, for example, in a time division duplex (TDD) band, the same frequency band is used for the sending band and the receiving band.

The term “power class” is a classification of output power of a user terminal (user equipment) specified according to a maximum output power, and a smaller power class value represents allowance of a higher maximum output power. For example, 3GPP specifies Power Classes 1, 1.5, 2, and 3. Specifically, Power Class 1 specifies a maximum output power of 31 dBm. Power Class 1.5 specifies a maximum output power of 29 dBm. Power Class 2 specifies a maximum output power of 26 dBm. Power Class 3 specifies a maximum output power of 23 dBm.

The maximum output power of a UE is defined based on the maximum output power at an end of an antenna. The maximum output power of the UE is measured by a method defined by 3GPP or the like. For example, incident power at the antenna is measured, and thereby the maximum output power is measured. As an alternative to the incident power measurement, a terminal is provided near the antenna, a measuring instrument is connected to the terminal (such as an antenna spectrum analyzer), and thereby the maximum output power of the antenna may be measured.

The term “band corresponding to a power class” means a frequency band for which the power class is usable and is defined by a standard or the like. For example, 3GPP discusses n2, n5, n8, n13, n25, n26, n28, n66, n71, n85, and the like as FDD bands for 5GNR corresponding to Power Class 2.

The phrase “a component is disposed on the substrate” includes disposition of the component on the main surface of the substrate and disposition of the component in the substrate. The phrase “a component is disposed on the main surface of a substrate” includes disposition of the component above the main surface without being in contact with the main surface (for example, the component is stacked on a different component disposed in contact with the main surface), in addition to disposition of the component in contact with the main surface of the substrate. The phrase “a component is disposed on the main surface of a substrate” may also include disposition of the component on a recessed portion formed in the main surface. The phrase “a component is disposed in the substrate” includes: encapsulation of the component in the module substrate; disposition of the entire component between main surfaces of the substrate and exposure of part of the component from the substrate; and disposition of only part of the component in the substrate.

The phrase “A is disposed between B and C” means that at least one of a plurality of lines connecting any point in B and any point in C passes through A. The phrase “A is closer to C than B” means that a distance between A and C is shorter than a distance between B and C. The term “a distance between A(B) and C” means the length of a shortest one of lines that each connect any point in A(B) and any point in C.

The term “plan view of a module substrate” means seeing an object orthographically projected on a plane parallel to the main surface of the module substrate from above the module substrate. The term “plan view of a module substrate” thus means seeing an object orthographically projected on an xy plane from a positive z-axis direction side.

Terms representing a relationship between elements such as “parallel” and “perpendicular”, a term representing the shape of an element such as “rectangular”, and a numerical value range indicate not only strict meaning but also inclusion of substantially the same range, for example, an error of approximately several percent.

### Embodiment 1

Embodiment 1 will be described. A communication apparatus 5 according to this embodiment is usable to provide wireless connection. For example, the communication apparatus 5 may be mounted on a UE in a cellular network for a mobile phone, a smartphone, a tablet computer, a wearable device, or the like (also referred to as a mobile network). In another example, mounting the communication apparatus 5 on an Internet of Things (IoT) sensor device, a medical/health-care device, a vehicle, an unmanned aerial vehicle (UAV) (a so-called drone), or an automated guided vehicle (AGV) enables a wireless connection to be provided. In still another example, mounting the communication apparatus 5 enables the wireless connection to be provided at a wireless access point or a wireless hotspot.

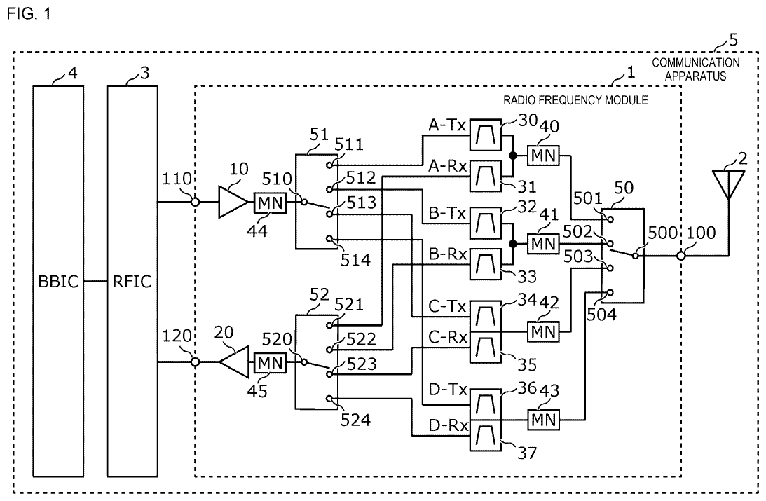

A circuit configuration of the communication apparatus 5 and a radio frequency module 1 according to this embodiment will be described with reference to FIG. 1. FIG. 1 is a circuit configuration diagram of the communication apparatus 5 according to this embodiment.

FIG. 1 illustrates an exemplary circuit configuration, and the communication apparatus 5 and the radio frequency module 1 may be mounted by using any of various circuit mounting and circuit techniques. Accordingly, the following description of the communication apparatus 5 and the radio frequency module 1 should not be construed in a limiting manner.

### 1.1 Circuit Configuration of Communication Apparatus 5

First, a circuit configuration of the communication apparatus 5 according to this embodiment will be described with reference to FIG. 1. The communication apparatus 5 includes a radio frequency module 1, an antenna 2, a radio frequency integrated circuit (RFIC) 3, and a baseband integrated circuit (BBIC) 4.

The radio frequency module 1 may transmit a radio frequency signal between the antenna 2 and the RFIC 3. The circuit configuration of the radio frequency module 1 will be described later.

The antenna 2 is connected to an antenna connection terminal 100 of the radio frequency module 1. The antenna 2 is capable of receiving a radio frequency signal from the radio frequency module 1 and sending a radio frequency signal to the outside of the communication apparatus 5. The antenna 2 is also capable of receiving a radio frequency signal from the outside of the communication apparatus 5 and outputting a radio frequency signal to the radio frequency module 1. The antenna 2 may be external to the communication apparatus 5. The communication apparatus 5 may also include one or more antennas in addition to the antenna 2.

The RFIC 3 is an example of a signal processing circuit that processes a radio frequency signal. Specifically, the RFIC 3 may perform signal processing on the sending signal input from the BBIC 4 by upconverting or the like and output a radio frequency sending signal generated by the signal processing to the radio frequency module 1. Further, the RFIC 3 may perform signal processing on a radio frequency receiving signal input via a receiving path of the radio frequency module 1 by downconverting or the like and output a receiving signal generated by the signal processing to the BBIC 4. The RFIC 3 may also have a controller that controls switches, a power amplifier, and the like of the radio frequency module 1. Part or all of the functions of the controller of the RFIC 3 may be included outside the RFIC 3 and may be included in, for example, the BBIC 4 or the radio frequency module 1.

The BBIC 4 is a baseband signal processing circuit that performs signal processing by using a frequency range lower than that of a radio frequency signal transmitted by the radio frequency module 1. For example, an image signal for image display and/or an audio signal for a talk using a speaker are used as signals processed by the BBIC 4. The BBIC 4 may be external to the communication apparatus 5.

### 1.2 Circuit Configuration of Radio Frequency Module 1

The circuit configuration of the radio frequency module 1 according to this embodiment will then be described with reference to FIG. 1. The radio frequency module 1 includes a power amplifier 10, a low-noise amplifier 20, filters 30, 31, 32, 33, 34, 35, 36, and 37, matching circuits 40, 41, 42, 43, 44, and 45, switch circuits 50, 51, and 52, the antenna connection terminal 100, a radio frequency input terminal 110, and a radio frequency output terminal 120.

The antenna connection terminal 100 is an external connection terminal of the radio frequency module 1. The antenna connection terminal 100 is connected to the antenna 2 outside the radio frequency module 1 and is connected to the switch circuit 50 inside the radio frequency module 1. The radio frequency module 1 is thereby capable of supplying a sending signal to the antenna 2 via the antenna connection terminal 100 and receiving a receiving signal from the antenna 2.

The radio frequency input terminal 110 is an external connection terminal of the radio frequency module 1. The radio frequency input terminal 110 is connected to the RFIC 3 outside the radio frequency module 1 and is connected to the power amplifier 10 inside the radio frequency module 1. The radio frequency module 1 is thereby capable of supplying a sending signal received from the RFIC 3 via the radio frequency input terminal 110 to the power amplifier 10.

The radio frequency output terminal 120 is an external connection terminal of the radio frequency module 1. The radio frequency output terminal 120 is connected to the RFIC 3 outside the radio frequency module 1 and is connected to the low-noise amplifier 20 inside the radio frequency module 1. The radio frequency module 1 is thereby capable of supplying a receiving signal amplified by the low-noise amplifier 20 to the RFIC 3 via the radio frequency output terminal 120.

The power amplifier 10 (PA) is connected between the radio frequency input terminal 110 and one of the filters 30, 32, 34, and 36. Specifically, an input end of the power amplifier 10 is connected to the radio frequency input terminal 110. In contrast, an output end of the power amplifier 10 is connected to the filter 30, 32, 34, or 36 in a switchable manner with the matching circuit 44 and the switch circuit 51 interposed therebetween. The power amplifier 10 is capable of amplifying a sending signal supplied from the RFIC 3 via the radio frequency input terminal 110 by using power supplied from a power supply.

Part or the entirety of the power amplifier 10 may be external to the radio frequency module 1. In this case, the part or the entirety of the power amplifier 10 may be connected between the RFIC 3 and the radio frequency input terminal 110 or may be included in the RFIC 3.

The low-noise amplifier 20 (LNA) is connected between one of the filters 31, 33, 35, and 37 and the radio frequency output terminal 120. Specifically, an input end of the low-noise amplifier 20 is connected to the filter 31, 33, 35, or 37 in a switchable manner with the matching circuit 45 and the switch circuit 52 interposed therebetween. In contrast, an output end of the low-noise amplifier 20 is connected to the radio frequency output terminal 120. The low-noise amplifier 20 is capable of amplifying a receiving signal that has passed through the filter 31, 33, 35, or 37 by using the power supplied from the power supply.

Part or the entirety of the low-noise amplifier 20 may be external to the radio frequency module 1. In this case, part or the entirety of the low-noise amplifier 20 may be connected between the radio frequency output terminal 120 and the RFIC 3 or may be included in the RFIC 3.

The filter 30 (A-Tx) is an example of a first filter and has a passband including a sending band of Band A. The filter 30 is connected between the antenna connection terminal 100 and the power amplifier 10. Specifically, one end of the filter 30 is connected to the antenna connection terminal 100 in a switchable manner with a matching circuit 40 and the switch circuit 50 interposed therebetween. In contrast, the other end of the filter 30 is connected to the power amplifier 10 in a switchable manner with the switch circuit 51 and the matching circuit 44 interposed therebetween. The filter 30 has an electric power handling capability corresponding to a first power class specified according to a relatively high maximum output power.

The first power class is a power class allowing the maximum output power higher than a maximum output power of a second power class. As the first power class, Power Class 2, Power Class 1.5, Power Class 1, or the like is used. If a new power class is defined in a standard, the new power class may be used as the first power class.

The filter 31 (A-Rx) is an example of a second filter and has a passband including a receiving band of Band A. The filter 31 is connected between the antenna connection terminal 100 and the low-noise amplifier 20. Specifically, one end of the filter 31 is connected to the antenna connection terminal 100 in a switchable manner with the matching circuit 40 and the switch circuit 50 interposed therebetween. In contrast, the other end of the filter 31 is connected to the low-noise amplifier 20 in a switchable manner with the switch circuit 52 and the matching circuit 45 interposed therebetween.

The filter 32 (B-Tx) has a passband including a sending band of Band B. The filter 32 is connected between the antenna connection terminal 100 and the power amplifier 10. Specifically, one end of the filter 32 is connected to the antenna connection terminal 100 in a switchable manner with the matching circuit 41 and the switch circuit 50 interposed therebetween. In contrast, the other end of the filter 32 is connected to the power amplifier 10 in a switchable manner with the switch circuit 51 and the matching circuit 44 interposed therebetween. The filter 32 has an electric power handling capability corresponding to the first power class.

The filter 33 (B-Rx) has a passband including a receiving band of Band B. The filter 33 is connected between the antenna connection terminal 100 and the low-noise amplifier 20. Specifically, one end of the filter 33 is connected to the antenna connection terminal 100 in a switchable manner with the matching circuit 41 and the switch circuit 50 interposed therebetween. In contrast, the other end of the filter 33 is connected to the low-noise amplifier 20 in a switchable manner with the switch circuit 52 and the matching circuit 45 interposed therebetween.

The filter 34 (C-Tx) is an example of a third filter or a fourth filter and has a passband including a sending band of Band C. The filter 34 is connected between the antenna connection terminal 100 and the power amplifier 10. Specifically, one end of the filter 34 is connected to the antenna connection terminal 100 in a switchable manner with the matching circuit 42 and the switch circuit 50 interposed therebetween. In contrast, the other end of the filter 34 is connected to the power amplifier 10 in a switchable manner with the switch circuit 51 and the matching circuit 44 interposed therebetween. The filter 34 has an electric power handling capability corresponding to the second power class specified according to the lower maximum output power. That is, the filter 34 may not handle electric power corresponding to the first power class.

The second power class is a power class specified according to the maximum output power lower than that of the first power class. For example, Power Class 3 is used as the second power class. If a new power class is defined in a standard, the new power class may be used as the second power class.

The filter 35 (C-Rx) is an example of the third filter or the fourth filter and has a passband including a receiving band of Band C. The filter 35 is connected between the antenna connection terminal 100 and the low-noise amplifier 20. Specifically, one end of the filter 35 is connected to the antenna connection terminal 100 in a switchable manner with the matching circuit 42 and the switch circuit 50 interposed therebetween. In contrast, the other end of the filter 35 is connected to the low-noise amplifier 20 in a switchable manner with the switch circuit 52 and the matching circuit 45 interposed therebetween. Alternatively, only one of the filters 34 and 35 may be included in the radio frequency module 1.

The filter 36 (D-Tx) has a passband including a sending band of Band D. The filter 36 is connected between the antenna connection terminal 100 and the power amplifier 10. Specifically, one end of the filter 36 is connected to the antenna connection terminal 100 in a switchable manner with the matching circuit 43 and the switch circuit 50 interposed therebetween. In contrast, the other end of the filter 36 is connected to the power amplifier 10 in a switchable manner with the switch circuit 51 and the matching circuit 44 interposed therebetween. The filter 36 has an electric power handling capability corresponding to the second power class. That is, the filter 36 may not handle the electric power corresponding to the first power class.

The filter 37 (D-Rx) has a passband including a receiving band of Band D. The filter 37 is connected between the antenna connection terminal 100 and the low-noise amplifier 20. Specifically, one end of the filter 37 is connected to the antenna connection terminal 100 in a switchable manner with the matching circuit 43 and the switch circuit 50 interposed therebetween. In contrast, the other end of the filter 37 is connected to the low-noise amplifier 20 in a switchable manner with the switch circuit 52 and the matching circuit 45 interposed therebetween.

Bands A to D are frequency bands for a communication system established by using radio access technology (RAT). Bands A to D are defined in advance by a standardization body and the like (for example, 3GPP and Institute of Electrical and Electronics Engineers (IEEE)). Examples of the communication system include a 5th Generation New Radio (5GNR) system, a Long Term Evolution (LTE) system, and a wireless local area network (WLAN) system.

Band A is an example of a first FDD band and a FDD band corresponding to the first power class. For example, n8 or n26 for 5GNR is used as Band A. Band A is not limited to these. For example, the LTE band may be used as Band A.

Band B is a FDD band corresponding to the first power class. A frequency band different from Band A is used as Band B, and, for example, n8 or n26 for 5GNR may be used. Band B is not limited to these. For example, the LTE band may be used as Band B.

Band C is an example of the second band and is a band corresponding to the second power class. Band C is thus a band not corresponding to the first power class. Band C may be any one of a FDD band, a TDD band, a supplementary uplink (SUL) band, and a supplementary downlink (SDL) band. If Band C is the TDD band, the filters 34 and 35 may be integrated into one sending/receiving filter. If Band C is the SUL band, the filter 35 may be omitted in the radio frequency module 1. If Band C is the SDL band, the filter 34 may be omitted in the radio frequency module 1. For example, n12, n13, or n71 for 5GNR is used as Band C. Band C is not limited to these. For example, the LTE band may be used as Band C.

Band D is a band corresponding to the second power class. Band D is thus a band not corresponding to the first power class. Band D may be any one of a FDD band, a TDD band, a SUL band, and a SDL band. If Band D is the TDD band, the filters 36 and 37 may be integrated into one sending/receiving filter. If Band D is the SUL band, the filter 37 may not be included in the radio frequency module 1. If Band D is the SDL band, the filter 36 may not be included in the radio frequency module 1. A frequency band different from Band C is used as Band D, and, for example, n12, n13, or n71 for 5GNR is used. Band D is not limited to these. For example, the LTE band may be used as Band D.

The matching circuit (a matching network) 40 (MN(ANT)) is connected between the switch circuit 50 and each of the filters 30 and 31 and is capable of impedance matching between the switch circuit 50 and each of the filters 30 and 31. The matching circuit 40 may include, for example, an inductor and/or a capacitor (what is called a shunt inductor and/or a shunt capacitor) connected between ground and a path connecting the switch circuit 50 and each of the filters 30 and 31. The matching circuit 40 may also include, for example, an inductor and/or a capacitor (what is called a series inductor and/or a series capacitor) connected between the switch circuit 50 and each of the filters 30 and 31. The matching elements included in the matching circuit 40 are not limited to the inductor and/or the capacitor. In addition, the matching circuit 40 may be external to the radio frequency module 1.

The matching circuit (a matching network) 41 (MN(ANT)) is connected between the switch circuit 50 and each of the filters 32 and 33 and is capable of impedance matching between the switch circuit 50 and each of the filters 32 and 33. The matching circuit 41 may include, for example, a shunt inductor and/or a shunt capacitor and may also include a series inductor and/or a series capacitor. The matching elements included in the matching circuit 41 are not limited to the inductor and/or the capacitor. In addition, the matching circuit 41 may not be included in the radio frequency module 1.

The matching circuit (a matching network) 42 (MN(ANT)) is connected between the switch circuit 50 and each of the filters 34 and 35 and is capable of impedance matching between the switch circuit 50 and each of the filters 34 and 35. The matching circuit 42 may include, for example, a shunt inductor and/or a shunt capacitor and may also include a series inductor and/or a series capacitor. The matching elements included in the matching circuit 42 are not limited to the inductor and/or the capacitor. In addition, the matching circuit 42 may not be included in the radio frequency module 1.

The matching circuit (a matching network) 43 (MN(ANT)) is connected between the switch circuit 50 and each of the filters 36 and 37 and is capable of impedance matching between the switch circuit 50 and each of the filters 36 and 37. The matching circuit 43 may include, for example, a shunt inductor and/or a shunt capacitor and may also include a series inductor and/or a series capacitor. The matching elements included in the matching circuit 43 are not limited to the inductor and/or the capacitor. In addition, the matching circuit 43 may not be included in the radio frequency module 1.

The matching circuit (a matching network) 44 (MN(PA)) is connected between the switch circuit 51 and the power amplifier 10 and is capable of impedance matching between the switch circuit 51 and the power amplifier 10. The matching circuit 44 may include, for example, a shunt inductor and/or a shunt capacitor and may also include a series inductor and/or a series capacitor. The matching elements included in the matching circuit 44 are not limited to the inductor and/or the capacitor. In addition, the matching circuit 44 may not be included in the radio frequency module 1.

The matching circuit (a matching network) 45 (MN(LNA)) is connected between the switch circuit 52 and the low-noise amplifier 20 and is capable of impedance matching between the switch circuit 52 and the low-noise amplifier 20. The matching circuit 45 may include, for example, a shunt inductor and/or a shunt capacitor and may also include a series inductor and/or a series capacitor. The matching elements included in the matching circuit 45 are not limited to the inductor and/or the capacitor. In addition, the matching circuit 45 may not be included in the radio frequency module 1.

The switch circuit 50 (SW(ANT)) is an example of a first switch circuit and is connected between the antenna connection terminal 100 and one of the filters 30 to 37. Specifically, the switch circuit 50 includes a common terminal 500 and selection terminals 501, 502, 503, and 504. The common terminal 500 is an example of a first common terminal and is connected to the antenna connection terminal 100. The selection terminal 501 is an example of a first selection terminal and is connected to each of the filters 30 and 31 with the matching circuit 40 interposed therebetween. The selection terminal 502 is connected to each of the filters 32 and 33 with the matching circuit 41 interposed therebetween. The selection terminal 503 is an example of a second selection terminal and is connected to each of the filters 34 and 35 with the matching circuit 42 interposed therebetween. The selection terminal 504 is connected to each of the filters 36 and 37 with the matching circuit 43 interposed therebetween.

In the connection configuration as described above, the switch circuit 50 may exclusively connect the common terminal 500 to one of the selection terminals 501 to 504, based on a control signal from, for example, the RFIC 3. The common terminal 500 is thus selectively connected to one of the selection terminals 501 to 504 in the switch circuit 50. The switch circuit 50 is configured by, for example, a SP4T switch circuit. The switch circuit 50 may not be included in the radio frequency module 1.

The switch circuit 51 (SW(PA)) is an example of a second switch circuit and is connected between one of the filters 30, 32, 34, and 36 and the power amplifier 10. Specifically, the switch circuit 51 includes a common terminal 510 and selection terminals 511, 512, 513, and 514. The common terminal 510 is an example of a second common terminal and is connected to the power amplifier 10 with the matching circuit 44 interposed therebetween. The selection terminal 511 is an example of a third selection terminal and is connected to the filter 30. The selection terminal 512 is connected to the filter 32. The selection terminal 513 is an example of a fourth selection terminal and is connected to the filter 34. The selection terminal 514 is connected to the filter 36.

In the connection configuration as described above, the switch circuit 51 may exclusively connect the common terminal 510 to one of the selection terminals 511 to 514, based on a control signal from, for example, the RFIC 3. The common terminal 510 is thus selectively connected to one of the selection terminals 511 to 514 in the switch circuit 51. The switch circuit 51 is configured by, for example, a SP4T switch circuit. The switch circuit 51 may not be included in the radio frequency module 1. In this case, the radio frequency module 1 may include a plurality of power amplifiers connected to the respective filters 30, 32, 34, and 36.

The switch circuit 52 (SW(LNA)) is an example of a third switch circuit and is connected between the low-noise amplifier 20 and one of the filters 31, 33, 35, and 37. Specifically, the switch circuit 52 includes a common terminal 520 and selection terminals 521, 522, 523, and 524. The common terminal 520 is an example of a third common terminal and is connected to the low-noise amplifier 20 with the matching circuit 45 interposed therebetween. The selection terminal 521 is an example of a fifth selection terminal and is connected to the filter 31. The selection terminal 522 is connected to the filter 33. The selection terminal 523 is an example of a sixth selection terminal and is connected to the filter 35. The selection terminal 524 is connected to the filter 37.

In the connection configuration as described above, the switch circuit 52 may exclusively connect the common terminal 520 to one of the selection terminals 521 to 524, based on a control signal from, for example, the RFIC 3. The common terminal 520 is thus selectively connected to one of the selection terminals 521 to 524 in the switch circuit 52. The switch circuit 52 is configured by, for example, a SP4T switch circuit. The switch circuit 52 may not be included in the radio frequency module 1. In this case, the radio frequency module 1 may include a plurality of low-noise amplifiers connected to the respective filters 31, 33, 35, and 37.

### 1.3 Mounting Example of Radio Frequency Module 1

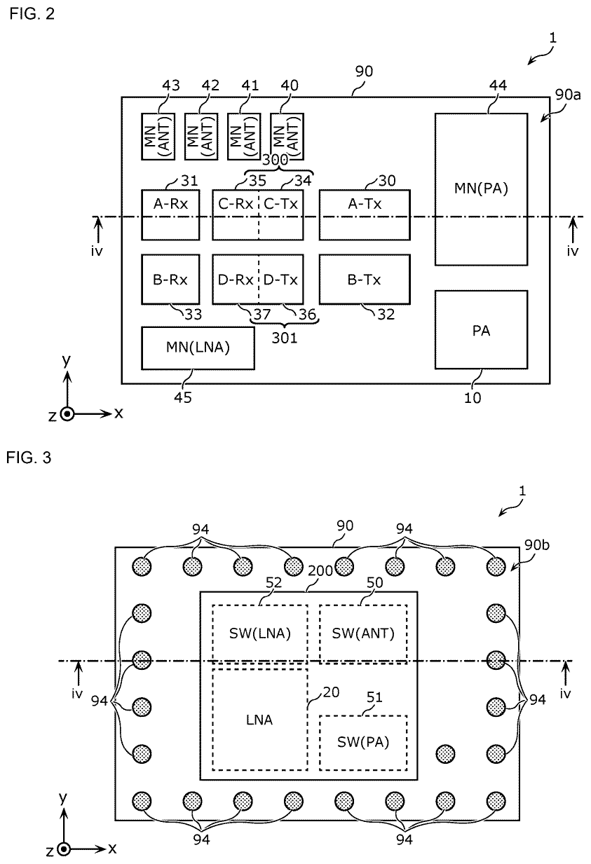

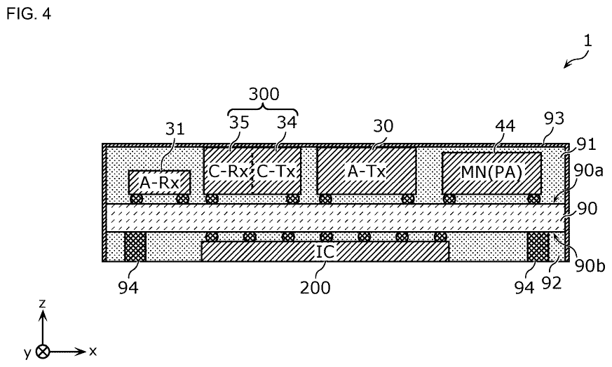

A mounting example of the radio frequency module 1 having the circuit configuration as described above will then be described with reference to FIGS. 2 to 4. FIG. 2 is a plan view of the radio frequency module 1 according to this embodiment. FIG. 3 is a plan view of the radio frequency module 1 according to this embodiment and is also a perspective view from the positive z-axis direction side to a main surface 90b of a module substrate 90. FIG. 4 is a cross-sectional view of the radio frequency module 1 according to this embodiment. The cross section of the radio frequency module 1 in FIG. 4 is a cross section taken along iv-iv line in FIGS. 2 and 3.

In FIGS. 2 to 4, components are labeled to indicate the components (such as PA) on occasions for easy understanding of an arrangement relationship of the components; however, actual components may not be labeled. In FIGS. 2 and 3, illustration of resin members 91 and 92 covering a plurality of circuit components and a shield layer 93 covering the resin members 91 and 92 is omitted.

FIGS. 2 to 4 illustrate a mounting example of the radio frequency module 1, and the mounting of the radio frequency module 1 may be performed by using any of various circuit mounting and circuit techniques. Accordingly, the following description of the radio frequency module 1 should not be construed in a limiting manner.

The radio frequency module 1 includes the module substrate 90, the resin members 91 and 92, the shield layer 93, and a plurality of external connection terminals 94, in addition to the plurality of circuit components illustrated in FIG. 1.

The module substrate 90 has a main surface 90a and the main surface 90b that are opposed to each other. The main surface 90a is referred to as an upper surface or a front surface in some cases. The main surface 90b is referred to as a lower surface or a back surface in some cases. Wiring lines, via conductors, and the like are formed in the module substrate 90 and on the main surfaces 90a and 90b; however, the illustration thereof is omitted.

As the module substrate 90, for example, one of a low temperature co-fired ceramics (LTCC) substrate and a high temperature co-fired ceramics (HTCC) substrate that have a layered structure of a plurality of dielectric layers, a component-embedded board, a substrate having a redistribution layer (RDL), or a printed circuit board may be used, but the module substrate 90 is not limited to these.

The resin member 91 covers at least part of the main surface 90a of the module substrate 90 and circuit components on the main surface 90a. The resin member 91 does not cover each of the top surfaces of a corresponding one of the filters 30 and 32 and duplexers 300 and 301, and each top surface of the corresponding one of the filters 30 and 32 and the duplexers 300 and 301 is exposed from the resin member 91 and in contact with the shield layer 93. For example, epoxy resin may be used as a material of the resin member 91; however, the material is not limited to this. The resin member 91 has a function of ensuring the reliability of the mechanical strength, the moisture resistance, and the like of the circuit components on the main surface 90a. The resin member 91 may not be included in the radio frequency module 1.

The resin member 92 covers at least part of the main surface 90b of the module substrate 90 and circuit components on the main surface 90b. The resin member 92 may not cover a top surface of an integrated circuit 200. The top surface of the integrated circuit 200 may thus be exposed from the resin member 92. For example, epoxy resin may be used as the material of the resin member 92; however, the material is not limited to this. The resin member 92 has a function of ensuring the reliability of the mechanical strength, the moisture resistance, and the like of the circuit components on the main surface 90b.

The shield layer 93 is a metal thin film formed, for example, by sputtering. As illustrated in FIG. 4, the shield layer 93 covers the surfaces of the resin members 91 and 92. The shield layer 93 also covers each top surface of the corresponding one of the filters 30 and 32 and the duplexers 300 and 301. The shield layer 93 is connected to ground and may reduce entry of external noise into the radio frequency module 1 and interference of noise generated in or on the radio frequency module 1 with another module or another apparatus.

The plurality of external connection terminals 94 are disposed on the main surface 90b of the module substrate 90. The plurality of external connection terminals 94 include the antenna connection terminal 100, the radio frequency input terminal 110, and the radio frequency output terminal 120 that are illustrated in FIG. 1. Further, the plurality of external connection terminals 94 include ground terminals connected to ground. Each of the plurality of external connection terminals 94 is electrically connected to a corresponding one of input/output terminals and/or ground terminals and the like on a mother board disposed in the negative direction of the z axis of the radio frequency module 1. Copper electrodes or solder electrodes may be used as the plurality of external connection terminals 94; however, the external connection terminals 94 are not limited to these.

The circuit components disposed on the main surfaces 90a and 90b of the module substrate 90 will be described with reference to FIGS. 2 to 4.

On the main surface 90a of the module substrate 90, the power amplifier 10, the filters 30 to 37, and the matching circuits 40 to 45 are disposed.

The power amplifier 10 may be configured by a heterojunction bipolar transistor (HBT) and may be manufactured by using a semiconductor material. For example, silicon germanium (SiGe) or gallium arsenide (GaAs) may be used as the semiconductor material. An amplifying transistor of the power amplifier 10 is not limited to the HBT. For example, the power amplifier 10 may be configured by a high electron mobility transistor (HEMT) or a metal-semiconductor field effect transistor (MESFET). In this case, gallium nitride (GaN) or silicon carbide (SiC) may be used as the semiconductor material.

The filters 30 to 37 are mounted by using a surface acoustic wave (SAW) filter, a bulk acoustic wave (BAW) filter, an LC resonator filter, a dielectric resonator filter, or a combination of any of these components. For example, the filters 30 and 32 may be BAW filters having a relatively high electric power handling capability, and the remaining filters may be SAW filters. The filters 30 to 37 are not limited to these.

The filters 30 and 31 are acoustic wave filters mounted on respective separate piezoelectric substrates. As illustrated in FIG. 4, a top surface of the filter 30 (a main surface on the positive z-axis direction side) is exposed from the resin member 91 and is in contact with the shield layer 93. The top surface of the filter 31 may not be in contact with the shield layer 93.

The filters 32 and 33 are acoustic wave filters mounted on respective separate piezoelectric substrates. Like the filter 30, a top surface of the filter 32 is exposed from the resin member 91 and is in contact with the shield layer 93. The top surface of the filter 33 may not be in contact with the shield layer 93.

The filters 34 and 35 are acoustic wave filters mounted on one piezoelectric substrate and are referred to as the duplexer 300. Alternatively, the filters 34 and 35 may be mounted on separate piezoelectric substrates.

As illustrated in FIG. 2, the duplexer 300 is disposed between the filters 30 and 31 in plan view of the module substrate 90. As illustrated in FIG. 4, the top surface of the duplexer 300 is exposed from the resin member 91 and is in contact with the shield layer 93. The top surface of the duplexer 300 may not be in contact with the shield layer 93.

The filters 36 and 37 are acoustic wave filters mounted on one piezoelectric substrate and are referred to as the duplexer 301. Alternatively, the filters 36 and 37 may be mounted on respective separate piezoelectric substrates.

As illustrated in FIG. 2, the duplexer 301 is disposed between the filters 32 and 33 in plan view of the module substrate 90. Like the duplexer 300, a top surface of the duplexer 301 is exposed from the resin member 91 and is in contact with the shield layer 93. The duplexer 301 may not be disposed between the filters 32 and 33, and the top surface of the duplexer 301 may not be in contact with the shield layer 93.

The matching circuits 40 to 45 are mounted as, for example, chip inductors and/or chip capacitors. The term “a chip inductor and/or a chip capacitor” means a surface mount device (SMD) forming an inductor and/or a capacitor. The form of mounting the matching circuits 40 to 45 is not limited to the chip inductor and/or the chip capacitor. For example, the matching circuits 40 to 45 may be mounted by using wiring patterns formed on the module substrate 90.

The integrated circuit 200 including the low-noise amplifier 20 and the switch circuits 50 to 52 are disposed on the main surface 90b of the module substrate 90.

The integrated circuit 200 (IC) may be manufactured by using a semiconductor material. Single-crystal silicon, gallium nitride (GaN), silicon carbide (SiC), or the like may be used as the semiconductor material.

The low-noise amplifier 20 and the switch circuits 50 to 52 may be configured by field effect transistors (FETs). The amplifying transistor of the low-noise amplifier 20 and switches included in the switch circuits 50 to 52 are not limited to FETs. For example, part or all of the low-noise amplifier 20 and the switch circuits 50 to 52 may be configured by bipolar transistors.

The low-noise amplifier 20 and the switch circuits 50 to 52 may not be included in one integrated circuit. For example, the low-noise amplifier 20 and the switch circuits 50 and 52 may be included in an integrated circuit different from the switch circuit 51. In this case, the switch circuit 51 may be included in the same integrated circuit as a control circuit that controls the power amplifier 10.

The mounting of the radio frequency module 1 is not limited to the mounting example in FIGS. 2 to 4. For example, the radio frequency module 1 may be mounted on one of the surfaces of the module substrate 90, instead of both sides of the module substrate 90.

### 1.4 Summarization

As described above, the radio frequency module 1 according to this embodiment includes the module substrate 90, the filter 30 disposed on the module substrate 90 and having the passband including the sending band of Band A corresponding to the first power class, the filter 31 disposed on the module substrate 90 and having the passband including the receiving band of Band A, and the filter 34 and/or the filter 35 disposed on the module substrate 90 and having the passband including at least part of Band C corresponding to the second power class that is specified according to the maximum output power lower than that of the first power class. The filter 34 and/or the filter 35 are disposed between the filters 30 and 31 in plan view of the module substrate 90.

With this configuration, the filter 34 and/or the filter 35 are disposed between the filters 30 and 31. Accordingly, heat propagation from the filter 30 to the filter 31 may be reduced, and deterioration in the characteristics of the filter 31 due to temperature rise in the filter 31 may be reduced. Further, capacitive coupling (electric field coupling) and/or inductive coupling (magnetic coupling) between the filters 30 and 31 may be reduced by using the filter 34 and/or the filter 35, and isolation between the sending path and the receiving path in Band A may be improved. In particular, the filter 30 for Band A corresponding to the first power class allowing the higher maximum output power is likely to undergo more heat generation and coupling occurrence, and thus reducing the heat propagation and coupling between the filters 30 and 31 leads to substantial improvement in the receiving characteristics of a signal in Band A.

For example, the radio frequency module 1 according to this embodiment may further include the resin member 91 and the shield layer 93, the resin member 91 covering at least part of the module substrate 90, the filters 30 and 31, and the filter 34 and/or 35, the shield layer 93 covering at least part of the resin member 91. The filter 34 and/or the filter 35 may be in contact with the shield layer 93.

With this configuration, the filter 34 and/or the filter 35 disposed between the filters 30 and 31 are in contact with the shield layer 93. The heat generated in the filter 30 may thus be effectively discharged via the filter 34 and/or the filter 35 and the shield layer 93, and the heat propagation from the filter 30 to the filter 31 may be reduced more effectively.

In addition, for example, in the radio frequency module 1 according to this embodiment, Band C may be a FDD band, and the radio frequency module 1 may include the filter 34 having the passband including the sending band of Band C and the filter 35 having the passband including the receiving band of Band C, and the filters 34 and 35 may be disposed between the filters 30 and 31 in plan view of the module substrate 90.

With this configuration, both of the filters 34 and 35 are disposed between the filters 30 and 31, and thus the advantageous effects of reducing heat propagation and coupling between the filters 30 and 31 may be enhanced.

For example, the radio frequency module 1 according to this embodiment may further include the switch circuit 50 that is disposed on the module substrate 90 and that connects the antenna connection terminal 100 to the filter 30, 31, 34, or 35 in a switchable manner, and the switch circuit 50 may include the common terminal 500 connected to the antenna connection terminal 100, the selection terminal 501 connected to the filters 30 and 31, and the selection terminal 503 connected to the filters 34 and 35.

With this configuration, the switch circuit 50 connects the filter 30 or 31 and the filter 34 or 35 to the antenna connection terminal 100 in a switchable manner, and thus the sending characteristics and the receiving characteristics of signals in Bands A and C may be improved.

For example, the radio frequency module 1 according to this embodiment may further include the power amplifier 10 disposed on the module substrate 90 and connected to the filters 30 and 34, and the switch circuit 51 that is disposed on the module substrate 90 and that connects the power amplifier 10 to the filter 30 or 34 in a switchable manner. The switch circuit 51 may include the common terminal 510 connected to the power amplifier 10, the selection terminal 511 connected to the filter 30, and the selection terminal 513 connected to the filter 34.

With this configuration, the power amplifier 10 may be shared to amplify a sending signal in Bands A and C, and thus the number of power amplifiers may be decreased to downsize the radio frequency module 1.

For example, the radio frequency module 1 according to this embodiment may further include the low-noise amplifier 20 disposed on the module substrate 90 and connected to the filters 31 and 35, and the switch circuit 52 that is disposed on the module substrate 90 and that connects the low-noise amplifier 20 to the filter 31 or 35 in a switchable manner. The switch circuit 52 may include the common terminal 520 connected to the low-noise amplifier 20, the selection terminal 521 connected to the filter 31, and the selection terminal 523 connected to the filter 35.

With this configuration, the low-noise amplifier 20 may be shared to amplify a receiving signal in Bands A and C, and thus the number of low-noise amplifiers may be decreased to downsize the radio frequency module 1.

For example, in the radio frequency module 1 according to this embodiment, Band A may be n8 or n26 for 5GNR, and Band C may be n12, n13, or n71 for 5GNR.

With this configuration, the receiving characteristics of a signal in n8 or n26 in 5GNR may be improved.

The communication apparatus 5 according to this embodiment includes the RFIC 3 configured to process a radio frequency signal and the radio frequency module 1 configured to transmit a radio frequency signal between the RFIC 3 and the antenna 2.

With this configuration, the same advantageous effects as those of the radio frequency module 1 may be provided with the communication apparatus 5.

### Modification 1 of Embodiment 1

Modification 1 of Embodiment 1 will then be described. This modification is different from Embodiment 1 mainly in the arrangement of the filters 30 and 32 on the main surface 90a of the module substrate 90. Hereinafter, this modification will be described with reference to the drawings, focusing on the difference from Embodiment 1.

### 1.5 Mounting Example of Radio Frequency Module 1

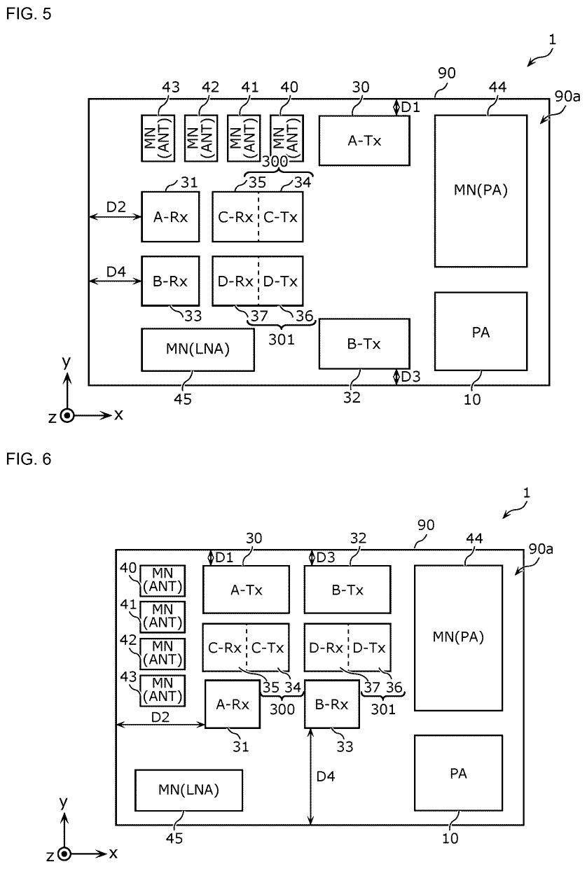

A mounting example of the radio frequency module 1 according to this modification will be described with reference to FIG. 5. FIG. 5 is a plan view of the radio frequency module 1 according to this modification. In FIG. 5, components are labeled to indicate the components (such as PA) on occasions for easy understanding of an arrangement relationship of the components; however, actual components may not be labeled. In FIG. 5, the illustration of the resin members 91 and 92 covering a plurality of circuit components and the shield layer 93 covering the resin members 91 and 92 is omitted.

FIG. 5 illustrates the mounting example of the radio frequency module 1, and the mounting of the radio frequency module 1 may be performed by using any of various circuit mounting and circuit techniques. Accordingly, the following description of the radio frequency module 1 should not be construed in a limiting manner.

In this modification as illustrated in FIG. 5, the filters 30 and 32 are disposed close to the outer peripheral edge of the module substrate 90. Specifically, in plan view of the module substrate 90, the filter 30 is closer to the outer peripheral edge of the module substrate 90 than the filter 31, and the filter 32 is closer to the outer peripheral edge of the module substrate 90 than the filter 33. More specifically, a distance D1 between the filter 30 and the outer peripheral edge of the module substrate 90 is shorter than a distance D2 between the filter 31 and the outer peripheral edge of the module substrate 90. A distance D3 between the filter 32 and the outer peripheral edge of the module substrate 90 is shorter than a distance D4 between the filter 33 and the outer peripheral edge of the module substrate 90.

The filter 32 may not be disposed close to the outer peripheral edge of the module substrate 90. The filter 32 may thus be farther from the outer peripheral edge of the module substrate 90 than the filter 33.

### 1.6 Summarization

As described above, in the radio frequency module 1 according to this modification, the filter 30 may be closer to the outer peripheral edge of the module substrate 90 than the filter 31 in plan view of the module substrate 90.

With this configuration, the property of heat dissipation from the filter 30 to the outside of the radio frequency module 1 may be improved, and temperature rise in the filter 30 may be reduced. Heat propagation from the filter 30 to the filter 31 may further be reduced, and deterioration in the characteristics of the filter 31 due to temperature rise in the filter 31 may further be reduced.

### Modification 2 of Embodiment 1

Modification 2 of Embodiment 1 will then be described. This modification is different from Embodiment 1 mainly in the arrangement of the filters 30 to 37 on the main surface 90a of the module substrate 90. Hereinafter, this modification will be described with reference to the drawings, focusing on the difference from Embodiment 1.

### 1.7 Mounting Example of Radio Frequency Module 1

A mounting example of the radio frequency module 1 according to this modification will be described with reference to FIG. 6. FIG. 6 is a plan view of the radio frequency module 1 according to this modification. In FIG. 6, components are labeled to indicate the components (such as PA) on occasions for easy understanding of an arrangement relationship of the components; however, actual components may not be labeled. In FIG. 6, the illustration of the resin members 91 and 92 covering a plurality of circuit components and the shield layer 93 covering the resin members 91 and 92 is omitted.

FIG. 6 illustrates the mounting example of the radio frequency module 1, and the mounting of the radio frequency module 1 may be performed by using any of various circuit mounting and circuit techniques. Accordingly, the following description of the radio frequency module 1 should not be construed in a limiting manner.

In plan view of the module substrate 90 as illustrated in FIG. 6, the duplexer 300 is disposed between the filter 30 and the power amplifier 10, and the duplexer 301 is disposed between the filter 32 and the power amplifier 10. The duplexer 301 may not be disposed between the filter 32 and the power amplifier 10.

Like Modification 1, the filters 30 and 32 are disposed close to the outer peripheral edge of the module substrate 90. Specifically, in plan view of the module substrate 90, the filter 30 is closer to the outer peripheral edge of the module substrate 90 than the filter 31, and the filter 32 is closer to the outer peripheral edge of the module substrate 90 than the filter 33. More specifically, the distance D1 between the filter 30 and the outer peripheral edge of the module substrate 90 is shorter than the distance D2 between the filter 31 and the outer peripheral edge of the module substrate 90. The distance D3 between the filter 32 and the outer peripheral edge of the module substrate 90 is shorter than the distance D4 between the filter 33 and the outer peripheral edge of the module substrate 90.

In this modification, the filter 30 and/or the filter 32 may not be disposed close to the outer peripheral edge of the module substrate 90. The filter 30 may thus be farther from the outer peripheral edge of the module substrate 90 than the filter 31, and the filter 32 may thus be farther from the outer peripheral edge of the module substrate 90 than the filter 33.

### 1.8 Summarization

As described above, the radio frequency module 1 according to this modification may further include the power amplifier 10 disposed on the module substrate 90 and connected to the filter 30, and the filter 34 and/or the filter 35 may be disposed between the power amplifier 10 and the filter 30 in plan view of the module substrate 90.

With this configuration, the filter 34 and/or the filter 35 with less heat generation are disposed in a portion between the power amplifier 10 with more heat generation and the filter 30, and temperature rise in the filter 30 may thus be reduced. Heat propagation from the filter 30 to the filter 31 may further be reduced, and deterioration in the characteristics of the filter 31 due to temperature rise in the filter 31 may further be reduced.

### Embodiment 2

Embodiment 2 will then be described. This embodiment is different from Embodiment 1 described above mainly in that filters disposed between the filter 30 and the power amplifier 10 are different from the filters (the filters 34 and 35 in Embodiment 1) disposed between the filters 30 and 31. Hereinafter, a radio frequency module 1A according to this embodiment will be described with reference to the drawings.

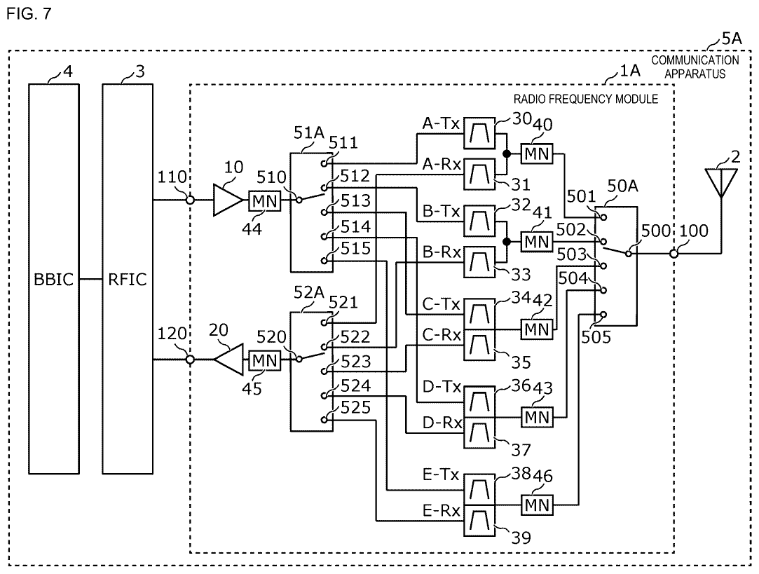

Like the communication apparatus 5 according to Embodiment 1, a communication apparatus 5A according to this embodiment may be used to provide a wireless connection. The communication apparatus 5A is identical to the communication apparatus 5 except that the communication apparatus 5A includes the radio frequency module 1A, instead of the radio frequency module 1. The description of the circuit configuration of the communication apparatus 5A is omitted, and the circuit configuration of the radio frequency module 1A will be described with reference to FIG. 7. FIG. 7 is a circuit configuration diagram of the communication apparatus 5A according to this embodiment.

FIG. 7 illustrates an exemplary circuit configuration, and the mounting of the communication apparatus 5A and the radio frequency module 1A may be performed by using any of various circuit mounting and circuit techniques. Accordingly, the following description of the radio frequency module 1A should not be construed in a limiting manner.

### 2.1 Circuit Configuration of Radio Frequency Module 1A

The radio frequency module 1A includes the power amplifier 10, the low-noise amplifier 20, the filters 30, 31, 32, 33, 34, 35, 36, and 37, filters 38 and 39, the matching circuits 40, 41, 42, 43, 44, and 45, a matching circuit 46, switch circuits 50A, 51A, and 52A, the antenna connection terminal 100, the radio frequency input terminal 110, and the radio frequency output terminal 120.

The filter 38 (E-Tx) is an example of a fifth filter and has a passband including a sending band of Band E. The filter 38 is connected between the antenna connection terminal 100 and the power amplifier 10. Specifically, one end of the filter 38 is connected to the antenna connection terminal 100 in a switchable manner with the matching circuit 46 and the switch circuit 50A interposed therebetween. In contrast, the other end of the filter 38 is connected to the power amplifier 10 in a switchable manner with the switch circuit 51A and the matching circuit 44 interposed therebetween. The filter 38 has an electric power handling capability corresponding to the second power class specified according to the lower maximum output power. That is, the filter 38 may not have the electric power handling capability corresponding to the first power class.

The filter 39 (E-Rx) is an example of a fifth filter and has a passband including a receiving band of Band E. The filter 39 is connected between the antenna connection terminal 100 and the low-noise amplifier 20. Specifically, one end of the filter 39 is connected to the antenna connection terminal 100 in a switchable manner with the matching circuit 46 and the switch circuit 50A interposed therebetween. In contrast, the other end of the filter 39 is connected to the low-noise amplifier 20 in a switchable manner with the switch circuit 52A and the matching circuit 45 interposed therebetween. It suffices that one of the filters 38 and 39 be included in the radio frequency module 1A, and the other one of the filters 38 and 39 may not be included in the radio frequency module 1A.

Band E is a frequency band for a communication system established by using the RAT, like Bands A to D. Band E is an example of a third band and is a band corresponding to the second power class. Band E is thus a band not corresponding to the first power class. Band E may be any one of a FDD band, a TDD band, a SUL band, and a SDL band. If Band E is the TDD band, the filters 38 and 39 may be integrated into one sending/receiving filter. If Band E is the SUL band, the filter 39 may not be included in the radio frequency module 1A. If Band E is the SDL band, the filter 38 may not be included in the radio frequency module 1A. A frequency band different from Bands C and D is used as Band E, and, for example, n12, n13, or n71 for 5GNR is used. Band E is not limited to these. For example, the LTE band may be used as Band E.

The matching circuit (a matching network) 46 (MN(ANT)) is connected between the switch circuit 50A and each of the filters 38 and 39 and is capable of impedance matching between the switch circuit 50A and each of the filters 38 and 39. The matching circuit 46 may include, for example, a shunt inductor and/or a shunt capacitor and may also include a series inductor and/or a series capacitor. The matching elements included in the matching circuit 46 are not limited to the inductor and/or the capacitor. In addition, the matching circuit 46 may not be included in the radio frequency module 1A.

The switch circuit 50A (SW(ANT)) is an example of the first switch circuit and is connected between the antenna connection terminal 100 and one of the filters 30 to 39. Specifically, the switch circuit 50A includes the common terminal 500, the selection terminals 501, 502, 503, and 504, and a selection terminal 505. The selection terminal 505 is connected to each of the filters 38 and 39 with the matching circuit 46 interposed therebetween.

In the connection configuration as described above, the switch circuit 50A may exclusively connect the common terminal 500 to one of the selection terminals 501 to 505, based on a control signal from, for example, the RFIC 3. The common terminal 500 is thus selectively connected to one of the selection terminals 501 to 505 in the switch circuit 50A. The switch circuit 50A is configured by, for example, a SP5T switch circuit. The switch circuit 50A may not be included in the radio frequency module 1A.

The switch circuit 51A (SW(PA)) is an example of the second switch circuit and is connected between one of the filters 30, 32, 34, 36, and 38 and the power amplifier 10. Specifically, the switch circuit 51A includes the common terminal 510, the selection terminals 511, 512, 513, and 514, and a selection terminal 515. The selection terminal 515 is connected to the filter 38.

In the connection configuration as described above, the switch circuit 51A may exclusively connect the common terminal 510 to one of the selection terminals 511 to 515, based on a control signal from, for example, the RFIC 3. The common terminal 510 is thus selectively connected to one of the selection terminals 511 to 515 in the switch circuit 51A. The switch circuit 51A is configured by, for example, a SP5T switch circuit. The switch circuit 51A may not be included in the radio frequency module 1A. In this case, the radio frequency module 1A may include a plurality of power amplifiers connected to the respective filters 30, 32, 34, 36, and 38.

The switch circuit 52A (SW(LNA)) is an example of the third switch circuit and is connected between the low-noise amplifier 20 and one of the filters 31, 33, 35, 37, and 39. Specifically, the switch circuit 52A includes the common terminal 520, the selection terminals 521, 522, 523, and 524, and a selection terminal 525. The selection terminal 525 is connected to the filter 39.

In the connection configuration as described above, the switch circuit 52A may exclusively connect the common terminal 520 to one of the selection terminals 521 to 525, based on a control signal from, for example, the RFIC 3. The common terminal 520 is thus selectively connected to one of the selection terminals 521 to 525 in the switch circuit 52A. The switch circuit 52A is configured by, for example, a SP5T switch circuit. The switch circuit 52A may not be included in the radio frequency module 1A. In this case, the radio frequency module 1A may include a plurality of low-noise amplifiers connected to the respective filters 31, 33, 35, 37, and 39.

### 2.2 Mounting Example of Radio Frequency Module 1A

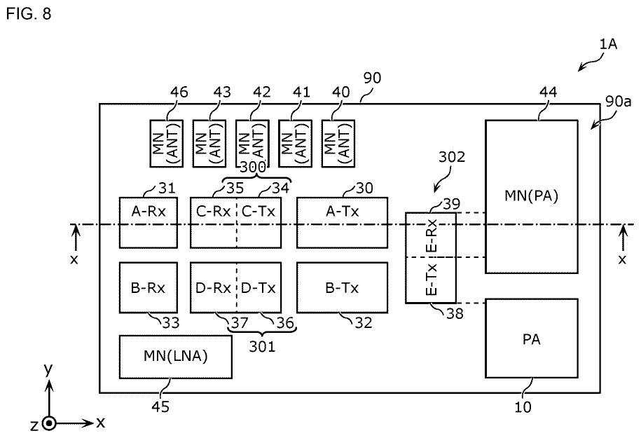

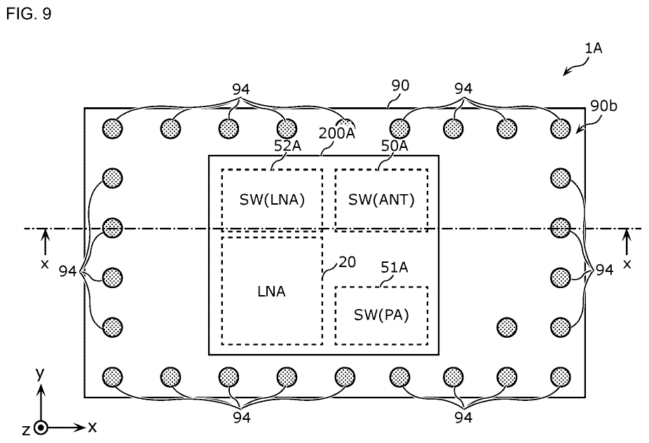

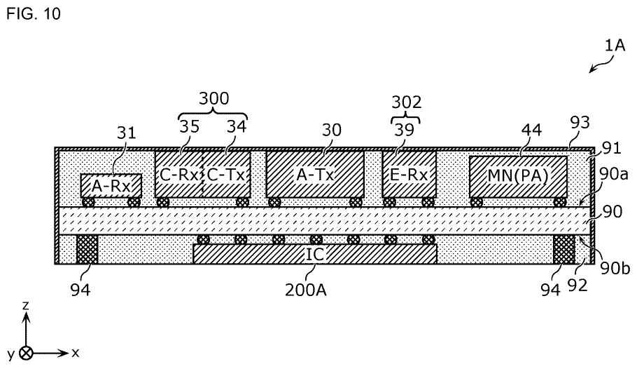

A mounting example of the radio frequency module 1A having the circuit configuration as described above will then be described with reference to FIGS. 8 to 10. FIG. 8 is a plan view of the radio frequency module 1A according to this embodiment. FIG. 9 is a plan view of the radio frequency module 1A according to this embodiment and is also a perspective view from the positive z-axis direction side to the main surface 90b of the module substrate 90. FIG. 10 is a cross-sectional view of the radio frequency module 1A according to this embodiment. The cross section of the radio frequency module 1A in FIG. 10 is a cross section taken along x-x line in FIG. 8 and FIG. 9.

In FIGS. 8 to 10, components are labeled to indicate the components (such as PA) on occasions for easy understanding of an arrangement relationship of the components; however, actual components may not be labeled. In FIGS. 8 and 9, the illustration of the resin members 91 and 92 covering a plurality of circuit components and the shield layer 93 covering the resin members 91 and 92 is omitted.

FIGS. 8 to 10 illustrate a mounting example of the radio frequency module 1A, and the mounting of the radio frequency module 1A may be performed by using any of various circuit mounting and circuit techniques. Accordingly, the following description of the radio frequency module 1A should not be construed in a limiting manner.

The radio frequency module 1A includes the module substrate 90, the resin members 91 and 92, the shield layer 93, and the plurality of external connection terminals 94, in addition to the plurality of circuit components illustrated in FIG. 7.

The filters 38 and 39 and the matching circuit 46 are disposed on the main surface 90a of the module substrate 90.

Like the filters 30 to 37, the filters 38 and 39 are mounted by using a SAW filter, a BAW filter, an LC resonator filter, a dielectric resonator filter, or a combination of any of these components. The filters 38 and 39 are not limited to these.

The filters 38 and 39 are acoustic wave filters mounted on one piezoelectric substrate and are referred to as a duplexer 302. Alternatively, the filters 38 and 39 may be mounted on respective separate piezoelectric substrates.

As illustrated in FIG. 8, in plan view of the module substrate 90, the duplexer 302 is disposed between the power amplifier 10 and the filter 30 and is disposed between the power amplifier 10 and the filter 32. Like the duplexers 300 and 301, the top surface of the duplexer 302 is exposed from the resin member 91 and is in contact with the shield layer 93. The duplexer 302 may not be disposed between the power amplifier 10 and the filter 32, and the top surface of the duplexer 302 may not be in contact with the shield layer 93.

Like the matching circuits 40 to 45, the matching circuit 46 is mounted as, for example, a chip inductor and/or a chip capacitor. The form of the mounting of the matching circuit 46 is not limited to a chip inductor and/or a chip capacitor. For example, the matching circuit 46 may be mounted by using a wiring pattern formed on the module substrate 90.

An integrated circuit 200A including the low-noise amplifier 20 and the switch circuits 50A to 52A is disposed on the main surface 90b of the module substrate 90.

The low-noise amplifier 20 and the switch circuits 50A to 52A may be configured by FETs. An amplifying transistor of the low-noise amplifier 20 and switches included in the switch circuits 50A to 52A are not limited to FETs. For example, part or all of the low-noise amplifier 20 and the switch circuits 50A to 52A may be configured by bipolar transistors.

Alternatively, the low-noise amplifier 20 and the switch circuits 50A and 52A may be included in an integrated circuit different from the switch circuit 51A. In this case, the switch circuit 51A may be included in the same integrated circuit as a control circuit that controls the power amplifier 10.

The mounting of the radio frequency module 1A is not limited to the mounting example in FIGS. 8 to 10. For example, the radio frequency module 1A may be mounted on one of the surfaces of the module substrate 90, instead of both sides of the module substrate 90.

### 2.3 Summarization

As described above, the radio frequency module 1A according to this embodiment further includes the power amplifier 10 disposed on the module substrate 90 and connected to the filter 30, and the filter 38 and/or the filter 39 disposed on the module substrate 90 and having the passband including at least part of Band E corresponding to the second power class. The filter 38 and/or the filter 39 may be disposed between the power amplifier 10 and the filter 30 in plan view of the module substrate 90.

With this configuration, the filter 38 and/or the filter 39 with less heat generation are disposed in a portion between the power amplifier 10 and the filter 30 with more heat generation, and temperature rise in the filter 30 may thus be reduced. Heat propagation from the filter 30 to the filter 31 may further be reduced, and deterioration in the characteristics of the filter 31 due to temperature rise in the filter 31 may further be reduced.

For example, the radio frequency module 1A according to this embodiment may further include the resin member 91 and the shield layer 93, the resin member 91 covering at least part of the module substrate 90, the filters 30, 31, and 34, and the filter 38 and/or 39, the shield layer 93 covering at least part of the resin member 91. The filter 38 and/or the filter 39 may be in contact with the shield layer 93.

With this configuration, the filter 38 and/or the filter 39 disposed between the power amplifier 10 and the filter 30 are in contact with the shield layer 93. Heat generated in the power amplifier 10 may thus be effectively discharged via the filter 38 and/or the filter 39 as well as the shield layer 93, and the heat propagation from the power amplifier 10 to the filter 30 may be reduced more effectively.

### Other Embodiments

The radio frequency module and the communication apparatus according to the present disclosure have heretofore been described based on the embodiments, but are not limited to the embodiments described above. Another embodiment implemented by combining any components in the embodiments above, modifications obtained by applying various changes conceived by those skilled in the art to the embodiments above without departing from the gist of the present disclosure, and various devices including the above-described radio frequency module are also included in the present disclosure.

For example, in the circuit configurations of the various circuits according to the embodiments above, another circuit element, another wiring line, and the like may be inserted between individual circuit elements and paths connecting signal paths disclosed in the drawings. For example, a low pass filter may be inserted between the switch circuit 50 or 50A and the antenna connection terminal 100.

Hereinafter, the features of the radio frequency module and the communication apparatus described based on the embodiments above will be described.
<1>

A radio frequency module includes
a module substrate,
a first filter disposed on the module substrate and having a passband including a sending band of a first FDD band corresponding to a first power class,
a second filter disposed on the module substrate and having a passband including a receiving band of the first FDD band, and
a third filter disposed on the module substrate and having a passband including at least part of a second band corresponding to a second power class that is specified according to a maximum output power lower than a maximum output power of the first power class.

The third filter is disposed between the first filter and the second filter in plan view of the module substrate.
<2>

In the radio frequency module according to <1>,
the first filter is closer to an outer peripheral edge of the module substrate than the second filter in the plan view of the module substrate.
<3>

The radio frequency module according to <1> or <2> further includes
a power amplifier disposed on the module substrate and connected to the first filter.

The third filter is disposed between the power amplifier and the first filter in the plan view of the module substrate.
<4>

The radio frequency module according to any one of <1> to <3> further includes
a resin member covering at least part of the module substrate, the first filter, the second filter, and the third filter, and
a shield layer covering at least part of the resin member.

The third filter is in contact with the shield layer.
<5>

In the radio frequency module according to any one of <1> to <4>,
the second band is a FDD band, and
the passband of the third filter includes one of a sending band and a receiving band that are included in the second band.

The radio frequency module further includes a fourth filter having a passband including a different one of the sending band and the receiving band that are included in the second band.

The fourth filter is disposed between the first filter and the second filter in the plan view of the module substrate.
<6>

The radio frequency module according to <5> further includes
a first switch circuit that is disposed on the module substrate and that connects an antenna connection terminal to the first filter, the second filter, the third filter, or the fourth filter in a switchable manner.

The first switch circuit includes
a first common terminal connected to the antenna connection terminal,
a first selection terminal connected to the first filter and the second filter, and
a second selection terminal connected to the third filter and the fourth filter.
<7>

The radio frequency module according to <5> or <6> further includes
a power amplifier disposed on the module substrate and connected to the first filter and the third filter, and
a second switch circuit that is disposed on the module substrate and that connects the power amplifier to the first filter or the third filter in a switchable manner.

The second switch circuit includes
a second common terminal connected to the power amplifier,
a third selection terminal connected to the first filter, and
a fourth selection terminal connected to the third filter.
<8>

The radio frequency module according to any one of <5> to <7> further includes
a low-noise amplifier disposed on the module substrate and connected to the second filter and the fourth filter, and
a third switch circuit that is disposed on the module substrate and that connects the low-noise amplifier to the second filter or the fourth filter in a switchable manner.

The third switch circuit includes
a third common terminal connected to the low-noise amplifier,
a fifth selection terminal connected to the second filter, and
a sixth selection terminal connected to the fourth filter.
<9>

The radio frequency module according to any one of <1> to <8> further includes
a power amplifier disposed on the module substrate and connected to the first filter, and
a fifth filter disposed on the module substrate and having a passband including at least part of a third band corresponding to the second power class.

The fifth filter is disposed between the power amplifier and the first filter in the plan view of the module substrate.
<10>

The radio frequency module according to <9> further includes
a resin member covering at least part of the module substrate, the first filter, the second filter, the third filter, and the fifth filter, and
a shield layer covering at least part of the resin member.

The fifth filter is in contact with the shield layer.
<11>

In the radio frequency module according to any one of <1> to <10>,
the first FDD band is n8 or n26 for 5GNR, and
the second band is n12, n13, or n71 for 5GNR.
<12>

A communication apparatus includes
a signal processing circuit configured to process a radio frequency signal, and
the radio frequency module according to any one of <1> to <11> configured to transmit the radio frequency signal between the signal processing circuit and an antenna.

### INDUSTRIAL APPLICABILITY

The present disclosure is widely usable for a communication apparatus such as a mobile phone, as a radio frequency module or a communication apparatus disposed in a front end portion.

### REFERENCE SIGNS LIST

1, 1A radio frequency module
2 antenna
3 RFIC
4 BBIC
5, 5A communication apparatus
10 power amplifier
20 low-noise amplifier
30, 31, 32, 33, 34, 35, 36, 37, 38, 39 filter
40, 41, 42, 43, 44, 45, 46 matching circuit
50, 50A, 51, 51A, 52, 52A switch circuit
90 module substrate
90a, 90b main surface
91, 92 resin member
93 shield layer
94 external connection terminal
100 antenna connection terminal
110 radio frequency input terminal
120 radio frequency output terminal
200, 200A integrated circuit
300, 301, 302 duplexer
500, 510, 520 common terminal
501, 502, 503, 504, 505, 511, 512, 513, 514, 515, 521, 522, 523, 524, 525 selection terminal
D1, D2, D3, D4 distance

1. A radio frequency module comprising:
a module substrate;
a first filter disposed on the module substrate and having a passband including a sending band of a first frequency division duplex (FDD) band corresponding to a first power class;
a second filter disposed on the module substrate and having a passband including a receiving band of the first FDD band; and
a third filter disposed on the module substrate and having a passband including at least part of a second band corresponding to a second power class, the second power class specifying a maximum output power lower than a maximum output power specified by the first power class,
wherein, in a plan view of the module substrate, the third filter is disposed between two elements selected from the group consisting of a power amplifier connected to the first filter, the first filter, and the second filter.

2. The radio frequency module according to claim 1, wherein the third filter is disposed between the first filter and the second filter in the plan view of the module substrate.

3. The radio frequency module according to claim 2,
wherein the first filter is closer to an outer peripheral edge of the module substrate than the second filter in the plan view of the module substrate.

4. The radio frequency module according to claim 2, wherein:
the power amplifier connected to the first filter is disposed on the module substrate,
the third filter is disposed between the power amplifier and the first filter in the plan view of the module substrate.

5. The radio frequency module according to claim 2, further comprising:
a resin member covering at least part of the module substrate, the first filter, the second filter, and the third filter; and
a shield layer covering at least part of the resin member,
wherein the third filter is in contact with the shield layer.

6. The radio frequency module according to claim 5, wherein the shield layer is connected to ground and is configured to dissipate heat generated by the first filter through the third filter and into the shield layer.

7. The radio frequency module according to claim 2,
wherein the second band is a FDD band,
wherein the passband of the third filter includes one of a sending band and a receiving band that are included in the second band,
the radio frequency module further comprising a fourth filter having a passband including a different one of the sending band and the receiving band that are included in the second band, and
wherein the fourth filter is disposed between the first filter and the second filter in the plan view of the module substrate.

8. The radio frequency module according to claim 7, further comprising:
a first switch circuit that is disposed on the module substrate and that connects an antenna connection terminal to the first filter, the second filter, the third filter, or the fourth filter in a switchable manner,
wherein the first switch circuit includes
a first common terminal connected to the antenna connection terminal,
a first selection terminal connected to the first filter and the second filter, and
a second selection terminal connected to the third filter and the fourth filter.

9. The radio frequency module according to claim 7, wherein the power amplifier connected to the first filter is disposed on the module substrate and is connected to the third filter, and the radio frequency module further comprises:
a second switch circuit that is disposed on the module substrate and that connects the power amplifier to the first filter or the third filter in a switchable manner,
wherein the second switch circuit includes
a second common terminal connected to the power amplifier,
a third selection terminal connected to the first filter, and
a fourth selection terminal connected to the third filter.

10. The radio frequency module according to claim 7, further comprising:
a low-noise amplifier disposed on the module substrate and connected to the second filter and the fourth filter; and
a third switch circuit that is disposed on the module substrate and that connects the low-noise amplifier to the second filter or the fourth filter in a switchable manner,
wherein the third switch circuit includes
a third common terminal connected to the low-noise amplifier,
a fifth selection terminal connected to the second filter, and
a sixth selection terminal connected to the fourth filter.

11. The radio frequency module according to claim 7, wherein
the third filter and the fourth filter are integrated on a single piezoelectric substrate as a duplexer, and
the duplexer is between the first filter and the second filter in the plan view of the module substrate.

12. The radio frequency module according to claim 2, wherein
the power amplifier connected to the first filter is disposed on the module substrate, and the radio frequency module further comprising
a fifth filter disposed on the module substrate and having a passband including at least part of a third band corresponding to the second power class,
wherein the fifth filter is disposed between the power amplifier and the first filter in the plan view of the module substrate.

13. The radio frequency module according to claim 12, further comprising:
a resin member covering at least part of the module substrate, the first filter, the second filter, the third filter, and the fifth filter; and
a shield layer covering at least part of the resin member,
wherein the fifth filter is in contact with the shield layer.

14. The radio frequency module according to claim 4, wherein the third filter is further disposed between the power amplifier and the first filter in the plan view of the module substrate.

15. The radio frequency module according to claim 2,
wherein the first FDD band is n8 or n26 for 5GNR, and
wherein the second band is n12, n13, or n71 for 5GNR.

16. The radio frequency module according to claim 1, further comprising an integrated circuit disposed on a second main surface of the module substrate opposite to a first main surface on which the first filter, the second filter, and the third filter are disposed, the integrated circuit including a low-noise amplifier and at least one switch circuit.

17. The radio frequency module according to claim 1, wherein the third filter is disposed between the power amplifier and the first filter in the plan view of the module substrate.

18. A communication apparatus comprising:
a signal processing circuit configured to process a radio frequency signal; and
the radio frequency module according to claim 1, configured to transmit the radio frequency signal between the signal processing circuit and an antenna.
